(19) United States
(12) Patent Application Publication
(10) Pub. No.: US 2008/0051091 A1
(43) Pub. Date: Feb. 28, 2008

(54) Apparatus, method and computer program product providing enhanced robustness of handover in E-UTRAN with paging of the active UE

(75) Inventors: Vinh Van Phan, Oulu (FI); Markku J. Vainikka, Kiviniemi (FI); Benoist Sebire, Tokyo (JP)

Correspondence Address: HARRINGTON & SMITH, PC, 4 RESEARCH DRIVE, SHELTON, CT, 06484-6212, US

(73) Assignee: Nokia Corporation

(21) Appl. No.: 11/895,508

(22) Filed: Aug. 24, 2007

Related U.S. Application Data
(60) Provisional application No. 60/840,283, filed on Aug. 25, 2006.

(51) Int. Cl. H04Q 7/20

(52) U.S. Cl. 455/436

(57) ABSTRACT

In a non-limiting aspect thereof, the exemplary embodiments of this invention provide a method that includes starting a timer in a base station after sending a handover information message, and stopping the timer upon a condition, including either receiving an expected handover related message, or expiration of a maximum allowed time value of the timer.

### CROSS-REFERENCE TO RELATED APPLICATIONS

This patent application claims priority under 35 U.S.C. § 119(e) from Provisional Patent Application No. 60/840,283 filed Aug. 25, 2006, the disclosure of which is incorporated by reference herein in its entirety.

### TECHNICAL FIELD

The exemplary and non-limiting embodiments of this invention relate generally to wireless communication systems, methods, devices and computer program products and, more specifically, relate to techniques for use during handover.

### BACKGROUND

Following are some acronyms used in the description below:

### 3GPP third generation partnership project

### UTRAN universal terrestrial radio access network

### EUTRAN evolved UTRAN

### OFDM orthogonal frequency division multiplex

### Node-B base station

eNB EUTRAN Node B

### UE user equipment

aGW access gateway

### HO handover

### RLL radio link layer

### RNL radio network layer

### PHY physical (layer 1 or L1)

### L2 layer 2 (e.g., the RLC/MAC layer)

### L3 layer 3 (e.g., the RRC layer)

### MME mobility management entity

### UPE user plane entity

### MAC medium access control

### RLC radio link control

### RRC radio resource control

### RRM radio resource management

### LTE long term evolution

### UL uplink (UE to Node-B)

### DL downlink (Node-B to UE)

### BSC base station controller

### GSM global system for mobile communications

### QOS quality of service

### RNTI radio network temporary identity

### C-RNTI cell-specific RNTI

### SIB system information block

A proposed communication system known as evolved UTRAN or E-UTRAN, and also referred to as UTRAN-LTE is presently under consideration within the 3GPP.

Of particular interest to the exemplary embodiments of this invention is a case of a basic HO scenario (intra E-UTRAN). Reference may be had to FIG. 2, derived from Section 9.1.5 of 3GPP TR 25.813, 3rd Generation Partnership Project; Technical Specification Group Radio Access Network; Evolved Universal Terrestrial Radio Access (E-UTRA) and Evolved Universal Terrestrial Radio Access Network (E-UTRAN); Radio Interface Protocol Aspects (Release 7), V7.0.0 (2006-06).

What follows is a description of the signal flow shown in FIG. 2 herein, as specified in 3GPP TR 25.813 (Release 7) for the intra-MME/UPE HO procedure.

Step 1: The UE is triggered to send a MEASUREMENT REPORT by the rules set by system information, specification etc.

Step 2: The Source eNB makes a decision based on the MEASUREMENT REPORT and/or RRM information to hand off the UE. The Source eNB prepares the target eNB for handover and passes relevant information in the Handover Request.

Step 3: The Target eNB prepares the HO with L1/L2 and responds to the source eNB by providing new C-RNTI and possibly other parameters such as access parameters, SIBs, etc. After reception of the accepted preparation of HO, the source eNB begins forwarding data packets to the target eNB.

Step 4: The UE receives a HANDOVER COMMAND with necessary parameters such as the new C-RNTI, possible starting time, target eNB SIBs, etc. The UE may need to acknowledge reception of the HO COMMAND with a RLC acknowledgment procedure (e.g., in GSM there is no acknowledgment).

Step 5: After expiry of the starting time in the HO COMMAND, the UE performs synchronization to the target eNB and then begins acquiring the UL timing advance.

Step 6: The network responds with UL allocation and timing advance. These are used by the UE to send a HANDOVER CONFIRM to the target eNB, which completes the handover procedure for the UE. It is probable that network needs to acknowledge reception of the HO CONFIRM with a RLC acknowledgment procedure.

Step 7a: The target eNB informs the success of the HO to the source eNB, which can then clear already forwarded data from its buffers. The source eNB still continues forwarding UE data if it has data in its buffers, or if the UPE still forwards data to it.

Step 7b: The UE location information is updated to the MME/UPE in order to enable the UPE to forward packets directly to the target eNB.

As may be appreciated, a question arises as to the consequences of the UE not correctly receiving the “DL allocation” and “HO command” at Step 4, as this is essential to the success/failure of the HO and, as a consequence, to providing the required or desired QoS.

### SUMMARY

In an exemplary aspect of the invention there is a method that comprises starting a timer in a base station after sending a handover information message, and stopping the timer upon a condition, comprising either receiving an expected handover related message, or expiration of a maximum allowed time value of the timer.

In another exemplary aspect of the invention there is a method that comprises starting a timer in a user equipment after an initiation of a handover procedure, and stopping the timer upon a condition, comprising either receiving an expected handover related message, or expiration of a maximum allowed time value of the timer, where at an expiration of the maximum allowed time value the user equipment begins listening for a page to obtain handover related information.

In yet another exemplary aspect of the invention, there is a computer readable medium encoded with a computer program executable by a processor to perform actions that comprise starting a timer in a base station after sending a handover information message, and stopping the timer upon a condition, comprising either receiving an expected handover related message, or expiration of a maximum allowed time value of the timer.

In yet another exemplary aspect of the invention, there is a computer readable medium encoded with a computer program executable by a processor to perform actions that comprise starting a timer in a user equipment after an initiation of a handover procedure, and stopping the timer upon a condition, comprising either receiving an expected handover related message, or expiration of a maximum allowed time value of the timer, where at an expiration of the maximum allowed time value the user equipment begins listening for a page to obtain handover related information.

In yet another exemplary aspect of the invention, there is an apparatus that comprises a handover control unit coupled to a transmitter configured to start a timer in a base station after sending a handover information message, and the handover control unit coupled to a receiver configured to stop the timer upon a condition, comprising either receiving an expected handover related message, or expiration of a maximum allowed time value of the timer.

In another exemplary aspect of the invention, there is an apparatus that comprises a handover control unit configured to start a timer in a user equipment after an initiation of a handover procedure, and the handover control unit coupled to a wireless receiver configured to stop the timer upon a condition, comprising either receiving an expected handover related message, or expiration of a maximum allowed time value of the timer, where at an expiration of the maximum allowed time value the wireless receiver of the user equipment is further configured to begin listening for a page to obtain handover related information.

In still another exemplary aspect of the invention there is an apparatus that comprises means for starting a timer in a base station after sending a handover information message, and means for stopping the timer upon a condition, comprising either receiving an expected handover related message, or expiration of a maximum allowed time value of the timer.

In another exemplary aspect of the invention, there is an apparatus that comprises means for starting a timer in a user equipment after an initiation of a handover procedure, and means stopping the timer upon a condition, comprising either receiving an expected handover related message, or expiration of a maximum allowed time value of the timer, where at an expiration of the maximum allowed time value the user equipment begins listening for a page to obtain handover related information.

In yet another exemplary aspect of the invention, there is a method that comprises sending a handover related message to a user equipment from a base station, starting a timer after sending the handover related message to the user equipment, and in the event the timer expires before receiving an expected response from the user equipment to the handover related message, the base station initiating a communication to the user equipment on a page channel, where the communication includes information contained in the handover related message.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 shows a simplified block diagram of various electronic devices that are suitable for use in practicing the exemplary embodiments of this invention.

FIG. 2 illustrates an Intra-MME/UPE HO, and is derived from FIG. 9.1.5 in 3GPP TR 25., 813 7.0.0, 2006-06).

FIG. 3 illustrates an Intra-MME/UPE HO that is enhanced in accordance with the exemplary embodiments of this invention.

FIG. 4A is a logic flow diagram that is illustrative of a method executed by an eNB in accordance with the exemplary embodiments of this invention.

FIG. 4B is a logic flow diagram that is illustrative of a further method executed by an eNB in accordance with the exemplary embodiments of this invention.

FIG. 5 is a logic flow diagram that is illustrative of a method executed by a UE in accordance with the exemplary embodiments of this invention.

FIG. 6A is a logic flow diagram that is illustrative of a method executed by a base station in accordance with the exemplary embodiments of this invention.

FIG. 6B is a logic flow diagram that is illustrative of a method executed by a user equipment in accordance with the exemplary embodiments of this invention.

FIG. 7 is a logic flow diagram that is illustrative of a method executed by a base station in accordance with the exemplary embodiments of this invention.

### DETAILED DESCRIPTION

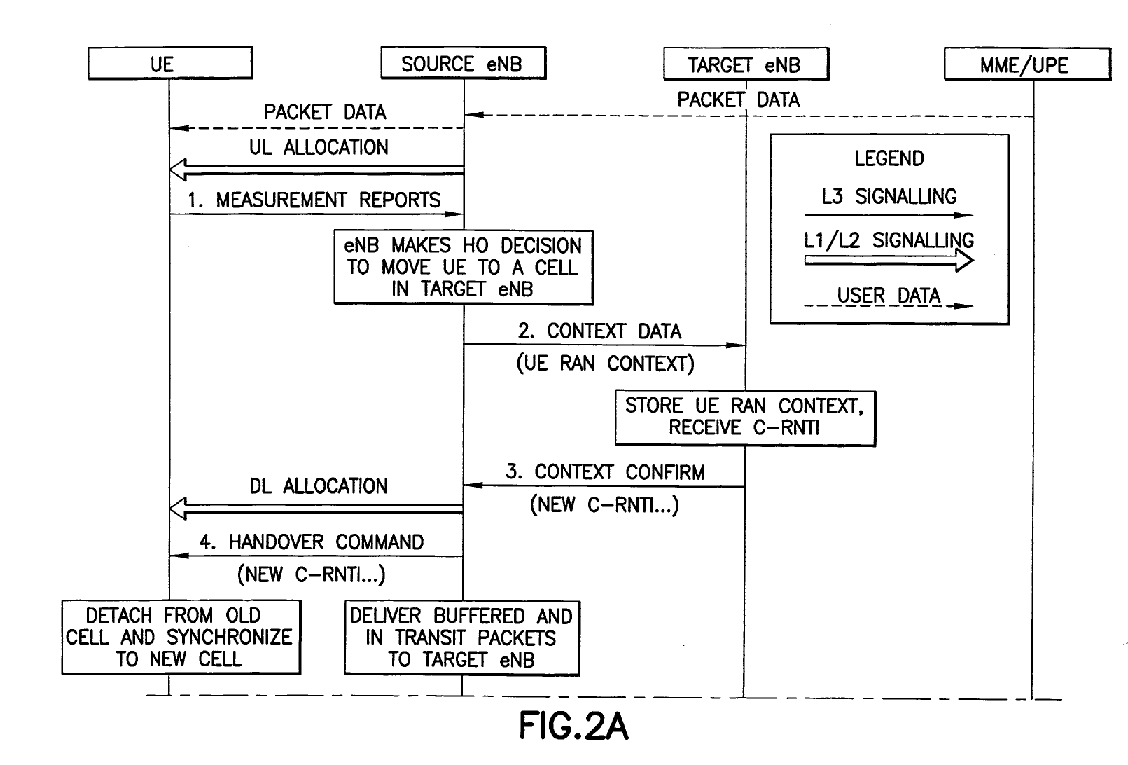

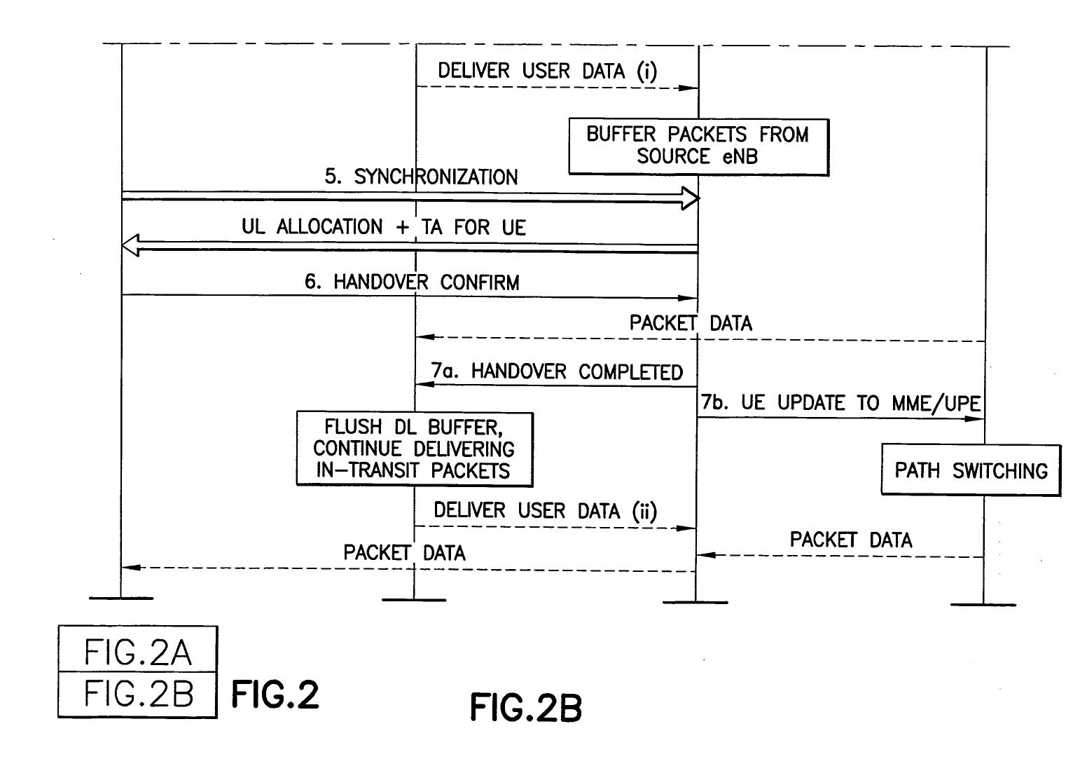

The exemplary embodiments of this invention address the foregoing and other problems, and provide support for a seamless and lossless HO in E-UTRAN that enhances the robustness of the HO against at least the situation discussed above, that is, the failure of the UE to correctly receive the HANDOVER COMMAND in Step 4 of FIG. 2.

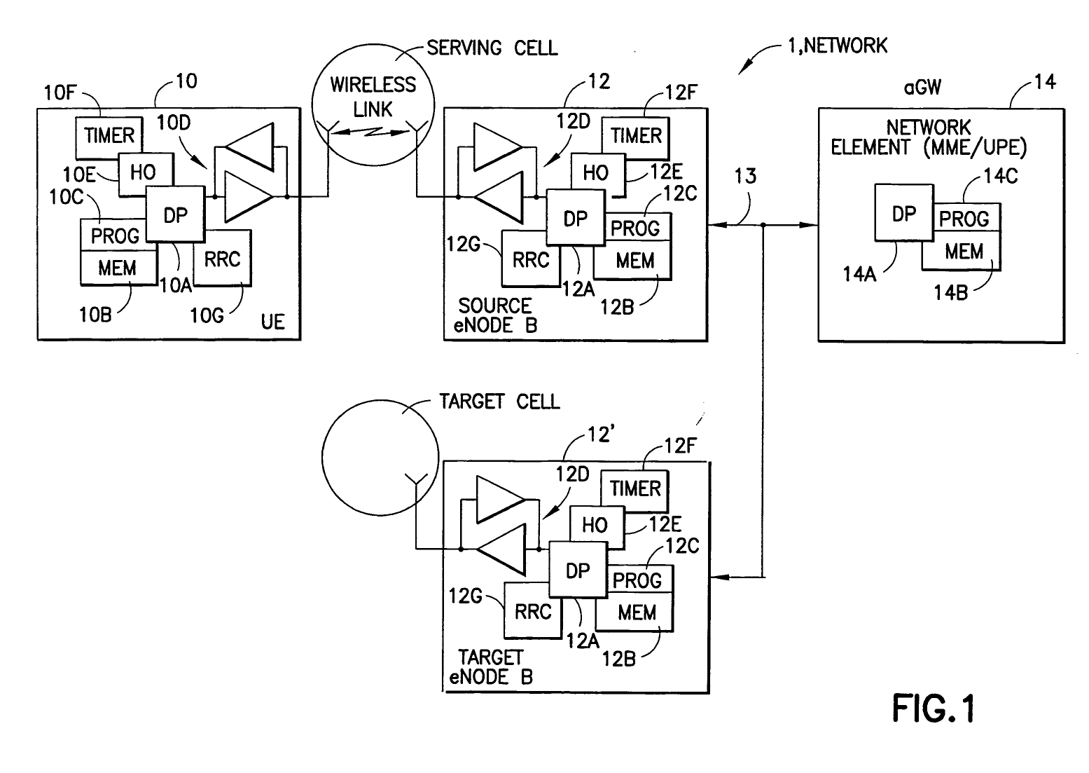

Reference is made first to FIG. 1 for illustrating a simplified block diagram of various electronic devices that are suitable for use in practicing the exemplary embodiments of this invention. In FIG. 1 a wireless network 1 is adapted for communication with a UE 10 via at least one Node B or base station 12 and also referred to herein as an eNode B 12 or eNB 12. The network 1 may include at least one Network Element 14 coupled to the eNode B 12 via a data link 13. The Network Element 14 may include the MME and UPE functionality, and in general may be referred to as the aGW 14. Herein the Network Element 14 may be referred to interchangeably as the MME/UPE 14 or as the aGW 14.

The UE 10 includes a data processor (DP) 10A, a memory (MEM) 10B that stores a program (PROG) 10C, and a suitable radio frequency (RF) transceiver 10D for bidirectional wireless communications with the eNode B 12, which also includes a DP 12A, a MEM 12B that stores a PROG 12C, and a suitable RF transceiver 12D. The eNode B 12 is coupled via the data path 13 to the aGW 14 (containing the MME/UPE functionality) that also includes at least one DP 14A and a MEM 14B storing an associated PROG 14C. At least one of the PROGs 10C, 12C and 14C is assumed to include program instructions that, when executed by the associated DP, enable the electronic device to operate in accordance with the exemplary embodiments of this invention, as will be discussed below in greater detail.

Also shown in FIG. 1 is at least one second eNode B, referred to as 12′. During a HO event the eNode B 12 may be considered the Source eNode B, i.e., the eNode B to which the UE 10 is currently connected and communicating in the associated serving cell, and the eNode B 12′ may be considered the Target eNode B, i.e., the eNode B to which the UE 10 is to be connected and communicating with in the target cell after the HO procedure is completed. Note that in practice the serving cell and the target cell may at least partially overlap one another.

Each eNode B 12, 12′ may be assumed to include a HO control function or unit 12E. Each eNode B 12, 12′ may be further assumed to include a Timer unit 12F, referred to below as Timer_T1, that operates in conjunction with the HO unit 12E. The UE 10 may be assumed to include a HO control function or unit 10E and an associated Timer 10F also referred to below as Timer_T2. The HO units 10E, 12E and Timer units 10F, 12F are constructed and operated in accordance with the exemplary embodiments of this invention, as described in greater detail below. Each eNode B 12, 12′ may also be assumed to include a RRC function 12G, the operation of which in certain exemplary embodiments of this invention is discussed below. A corresponding RRC function 10G is shown in the UE 10.

It should be noted that while the HO and timer units 10E, 12E, 10F, 12F are shown as separate elements in FIG. 1, in practice they may form a part of the respective RRC functions 10G, 12G, as the RRC typically embodies the primary radio interface control protocol.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The exemplary embodiments of this invention may be implemented by computer software executable by the DP 10A of the UE 10, the DP 12A of the eNode Bs 12 and 12′, the DP 14A of the aGW 14, or by hardware, or by a combination of software and hardware.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

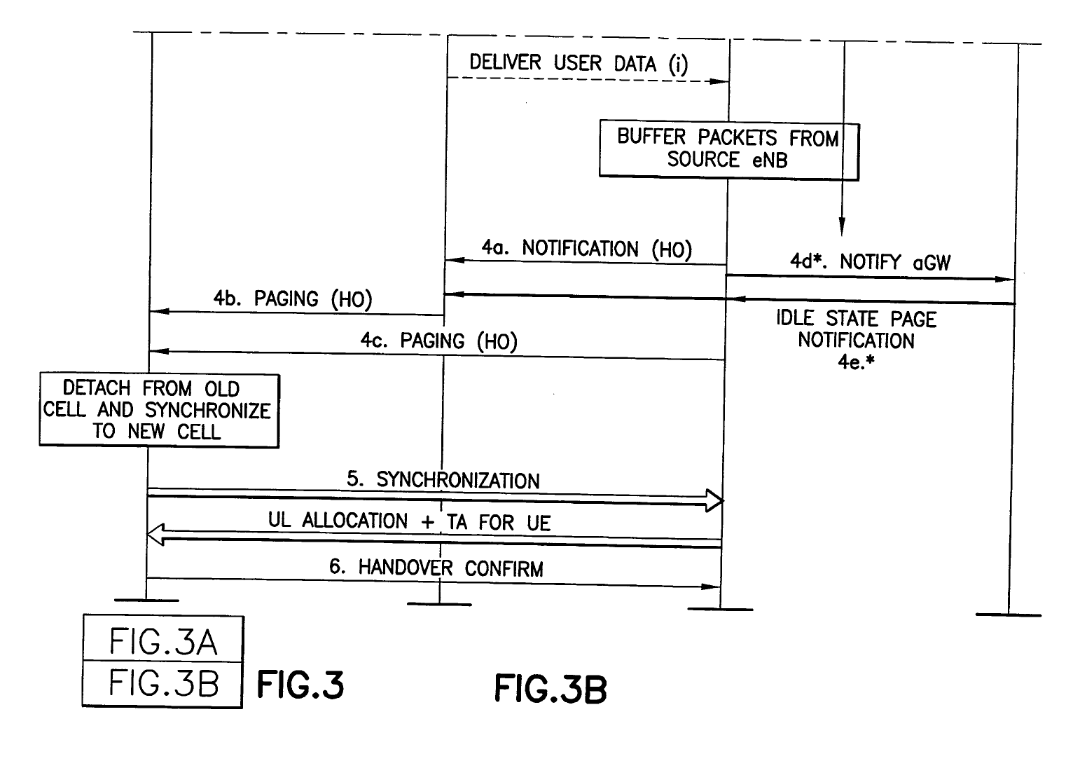

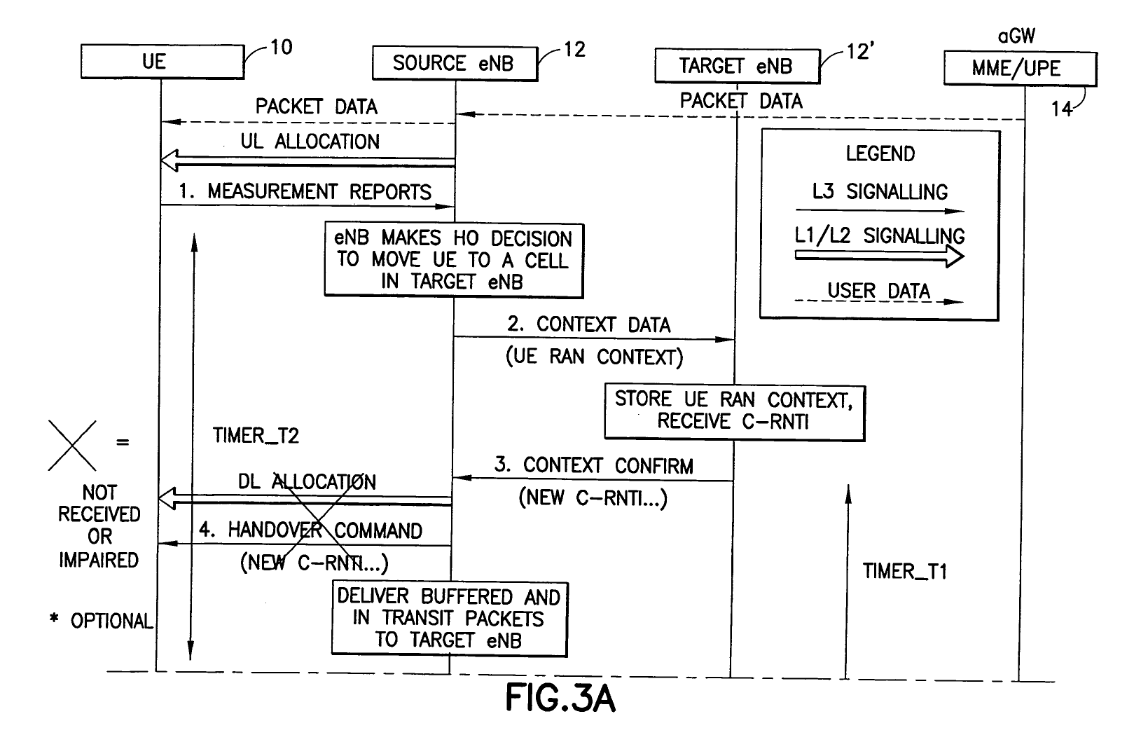

Describing now the exemplary embodiments of this invention in even further detail, and referring to FIG. 3, the HO related Timer_T1 12F is provided at the eNBs 12, 12′ and the Timer_T2 10E is provided at the UE 10. Timer_T1 12F is defined as a HO guard timer of the eNB 12, 12′, and in the example shown in FIG. 3 Timer_T1 is used by the target eNB 12′, and is started at the time that the target eNB 12′ sends the Context Confirm message to the source eNB 12 as in Step 3. Timer_T1 12F is used to check that a signal is received from the UE 10 by Step 5 or 6 at the latest. Thus, the condition to stop Timer_T1 12F is after successful completion of Step 5 or 6. In another embodiment, Timer_T1 12F is used by the source eNB 12, is started after Step 4, and is stopped when reaching Step 7a. Timer_T2 10F is defined as a HO guard timer of the UE 10, and may be started when the UE 10 sends the Measurement Report to the source eNB such as at Step 1, i.e., when the UE 10 expects to receive HO Command from the source eNB 12 as in Step 4. Thus, a suitable condition to stop Timer_T2 10F is at the successful completion of Step 4. Both Timer_T1 and Timer_T2 may be considered as cell-specific network system parameters, and the maximum duration of Timer_T1 and Timer_T2 is preferably less than the allowed or expected HO execution time. The value for Timer_T2 may be sent to, and subsequently updated in, the UE 10 in, for example, cell-specific broadcast system information.

As can be appreciated, if either Timer_T1 and Timer_T2 times out, i.e., reaches the maximum allowed time value measured in, for example, milliseconds or seconds, then it can be assumed that an error has occurred during the HO signaling message flow, and corrective action can be taken.

For example, in the event that Timer_T1 12F expires and the eNB 12 does not receive an expected message, and for the case where Timer_T1 12F is applied in the target eNB 12′ as shown in FIG. 3, the target eNB 12′ may notify the source eNB 12 of the time-out of Timer_1 and may provide any related information updates as shown in FIG. 3, for convenience, as message 4a. In response to this notification, the source eNB 12B may begin paging the ACTIVE state UE 10 in the current cell as shown in FIG. 3, for convenience, as message 4b. The paging can occur by whatever suitable technique is selected for use in E-UTRAN. In this case the content of a Paging Cause and a Paging Record sent to the UE 10 may repeat all of the content of HO Command, including the new C-RNTI with the most recent valid updates. The target eNB 12′ may also page the ACTIVE state UE 10 in the target cell and, in this case, the content of the paging message can be similar to that sent by the source eNB 12 to facilitate the HO as shown in FIG. 3, for convenience, as an optional message 4c.

Further by example, and in the event that Timer_T1 12F expires and the eNB 12 does not receive an expected message, and for the case where Timer_T1 is used in the source eNB 12, the source eNB 12 begins paging the ACTIVE state UE in the current cell as in message 4b in FIG. 3. As before, the content of a Paging Cause and a Paging Record sent to the UE 10 may repeat all of the content of HO Command, including the new C-RNTI with the most recent valid updates.

In the event that Timer_T2 10F expires, and the UE 10 does not receive the expected message(s) from the network, such as from the source eNB 12 in the current cell, the UE 10 begins listening to the paging channel of the current cell and, if possible, to the paging channel(s) of those neighboring cell(s) that the UE was able to measure and report at Step 1 in FIG. 3. In this case the UE 10 is enabled to receive the HO command and associated information from one of the received Pages and is enabled to respond to the received Page, and associated HO-related information, either from the source or target eNB 12, 12′ and continue from Step 5 of FIG. 3. That is, the UE 10 is provided the expected HO Command and associated information through an alternate signaling mechanism (i.e., through a Paging channel).

It can be noted that in current LTE E-UTRAN system concepts the paging of an IDLE state UE 10 is originated from the aGW 14, and the PAGING message is formed and sent by the RRC unit 12G of the eNB 12. However, in accordance with the exemplary embodiments of this invention the eNB RRC unit 12G is permitted to initiate paging of an ACTIVE state UE 10 for control purposes. The source eNB 12 may use the currently valid, also referred to as the old C-RNTI as the UE ID for paging. In the case where the target eNB 12′ is also allowed to page the UE 10, as shown in message 4c of FIG. 3, the RRC function 12G of the target eNB 12′ may use the old C-RNTI, or some other ID, of the UE 10, which is known from the context data received from the source eNB 12 in Step 2.

However, if the radio connection is actually lost, and the RRC is not allowed to initiate paging of the ACTIVE state UE 10, it is within the scope of the exemplary embodiments of this invention for the source or target eNB 12, 12′ to notify the aGW 14 upon the expiry of Timer_T1 so that urgent paging can be initiated from the aGW 14, and Timer_T2 may be generalized and extended so as to force the UE 10 back to the IDLE state, as from the ACTIVE state, to listen for possible urgent paging initiated by the aGW 14.

It can be noted that in this case the eNB 12 may send the HO command and related information to the aGW 14 to be included in the IDLE state page, or the eNB 12 RRC functionality 12G may know that the IDLE state page initiated by the aGW 14 should include this information. In either case it is most desirable that the aGW 14 request only a subset of the eNBs located in a paging area to page the UE 10, such as only the source eNB 12 and the target eNB 12′. As such, the paging notification sent from the aGW 14 preferably includes at least the identifications of the involved source and target eNBs 12, 12′.

Optional messages 4d and 4e in FIG. 3 show this process for an example where the target eNB 12′ sends a Notify message to the aGW 14, and the aGW 14 sends an IDLE state Page Notification to both the source eNB 12 and the target eNB 12′. As was noted, the HO command and related information could be sent as part of the Notification message 4d. In this case it is assumed that the expiration of Timer_T2 10F has triggered the UE 10 to enter the IDLE state so as to receive the IDLE state page from one of the eNBs 12, 12′ so as to perform the HO recovery process.

For the case where the UE 10 transitions back to the IDLE state to receive the page, it is not implied that the current call is dropped. For example, a temporary state transition to IDLE may be performed for call recovery purposes so as to receive the necessary HO information. During this period the ACTIVE context of the UE 10 may remain in effect, at least for some predetermined maximum amount of time such as one set by an associated RRC 10G timer.

Note further in this regard that the UE 10 needs to contact the target eNB 12′ to establish the radio connection and become RRC_ACTIVE, and during this time the target eNB 12 may communicate with the MME/UPE 14 to resume the LTE_ACTIVE state.

It can be further noted that in certain previous systems a central node, such as the RNC in UTRAN and a BSC in GSM, was responsible for HO, and timers have been defined to cope with HO failure, for example the timers T3103 and T3124 in GSM. However, the HO execution in the E-UTRAN system that is of particular interest to the exemplary embodiments of this invention does not involve a central node, and instead it is handled locally by the eNBs 12, 12′. Thus, an aspect of the exemplary embodiments of this invention is in providing distributed HO-related timers (Timer_1, Timer_2) at those nodes, like the eNBs 12 and UE 10, where the HO-related signaling and control resides.

Clearly, the use of the exemplary embodiments of this invention provides a simple and effective technique to enhance the robustness of the intra E-UTRAN handover.

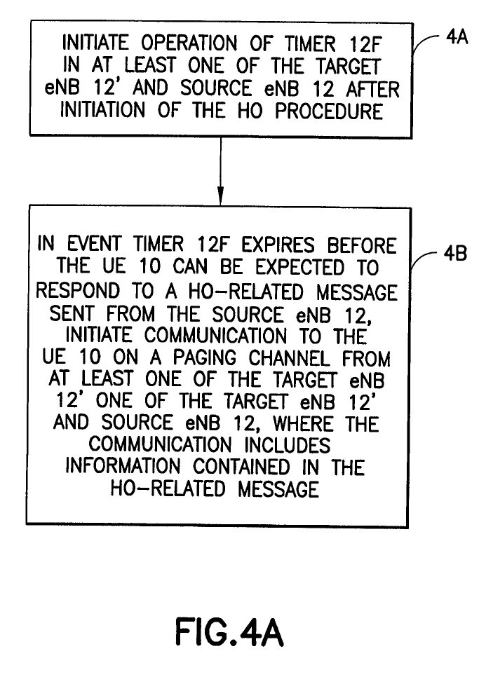

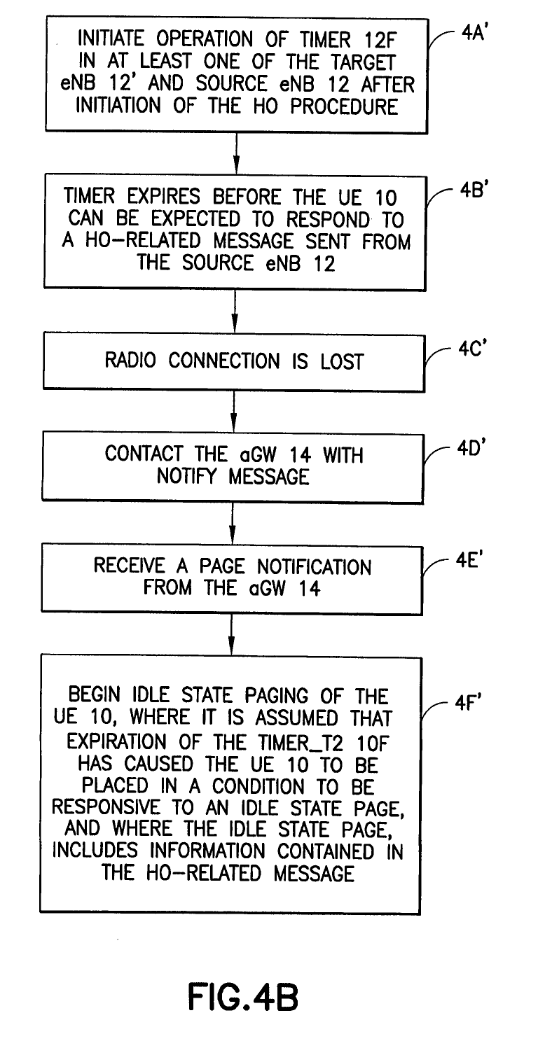

Referring to FIG. 4A, it should be appreciated that the exemplary embodiments of this invention, in one aspect thereof, provide a method for HO of the UE 10 by: initiating operation of a timer in at least one of the target eNB 12′ and source eNB 12 after initiation of the HO procedure (Step 4A) and, in the event the timer expires before the UE 10 can be expected to respond to a HO-related message sent from the source eNB 12, initiating (at Step 4B) a communication to the UE 10 on a Paging channel from at least one of the target eNB 12′ and source eNB 12, where the communication includes information contained in the HO-related message.

During operation of Step 4B, and if the communication is initiated by the target eNB 12′, the target eNB sends a notification to the source eNB 12, and the source eNB 12 sends the communication in a Paging channel of the serving cell. The target eNB 12′ may also send the communication in a Paging channel of the target cell. During operation Step 4B, the UE 10 may be in the ACTIVE state.

Referring to FIG. 4B, it should be appreciated that the exemplary embodiments of this invention, in a further aspect thereof, provide a method for HO of the UE 10 by: initiating operation of a timer in at least one of the target eNB 12′ and source eNB 12 after initiation of the HO procedure (Step 4A′) and, in the event the timer expires before the UE 10 can be expected to respond to a HO-related message sent from the source eNB 12 (Step 4B′), and in the event that it is determined that the radio connection is lost (Step 4C′), contacting the aGW 14 with a notify message (Step 4D′) and, in response to receiving a page notification from the aGW 14 (Step 4E′), beginning IDLE state paging of the UE 10 (Step 4F′), where it is assumed that expiration of the Timer_T2 10F has caused the UE 10 to (at least temporarily) be placed in a condition to be responsive to an IDLE state page, and where the IDLE state page includes information contained in the HO-related message.

It should be further appreciated that the exemplary embodiments of this invention, in a further aspect thereof, provide an eNB-resident computer program product that functions to perform HO of the UE 10 by: initiating operation of a timer in at least one of the target eNB 12′ and source eNB 12 after initiation of the HO procedure and, in the event the timer expires before the UE 10 can be expected to respond to a HO-related message sent from the source eNB 12, initiating a communication to the UE 10 on a Paging channel from at least one of the target eNB 12′ and source eNB 12, where the communication includes information contained in the HO-related message.

It should be further appreciated that the exemplary embodiments of this invention, in another aspect thereof, provide a network device, such as the eNB, that is constructed to perform HO of the UE 10, and that includes a timer unit and a unit to initiate operation of the timer unit in at least one of the target eNB 12′ and source eNB 12 after the HO procedure is started and, in the event the timer expires before the UE 10 can be expected to respond to a HO-related message sent from the source eNB 12, to initiate a communication to the UE 10 on a Paging channel from at least one of the target eNB 12′ and source eNB 12, where the communication includes information contained in the HO-related message.

Referring to FIG. 5, it should be appreciated that the exemplary embodiments of this invention, in another aspect thereof, provide a method for the UE 10 to perform a HO procedure by: initiating operation of a timer after the start of the HO procedure (Step 5A); and, in the event the timer expires before the UE 10 receives an expected HO-related message sent from a source eNB, to begin listening (Step 5B) to a Paging channel of a current cell and, optionally, to Paging channel(s) of neighboring cell(s); to receive (Step 5C) the expected HO-related message and associated information from a received page; and to continue with the HO procedure (Step 5D) using the HO-related message and associated information received through the Paging channel.

The UE 10 may be in the Active state for Steps B and C, or it may transition to the IDLE state before beginning to listen to the Paging channel.

It should be further appreciated that the exemplary embodiments of this invention, in a further aspect thereof, provide a UE 10 resident computer program product that functions to perform a HO procedure by: initiating operation of a timer after the start of the HO procedure; and, in the event the timer expires before the UE 10 receives an expected HO-related message sent from a source eNB, to begin listening to a Paging channel of a current cell and, optionally, to Paging channel(s) of neighboring cell(s); to receive the expected HO-related message and associated information from a received page; and to continue with the HO procedure using the HO-related message and associated information received through the Paging channel.

It should be further appreciated that the exemplary embodiments of this invention, in still another aspect thereof, provide the UE 10 that is constructed to a perform HO procedure, and that includes a timer unit and a unit to initiate operation of the timer unit after the start of the HO procedure; where in the event the timer unit expires before the UE 10 receives an expected HO-related message sent from a source eNB, the UE 10 begins to receive a Paging channel of a current cell and, optionally, a Paging channel(s) of neighboring cell(s); to receive the expected HO-related message and associated information from a received page; and to continue with the HO procedure using the HO-related message and associated information received through the Paging channel.

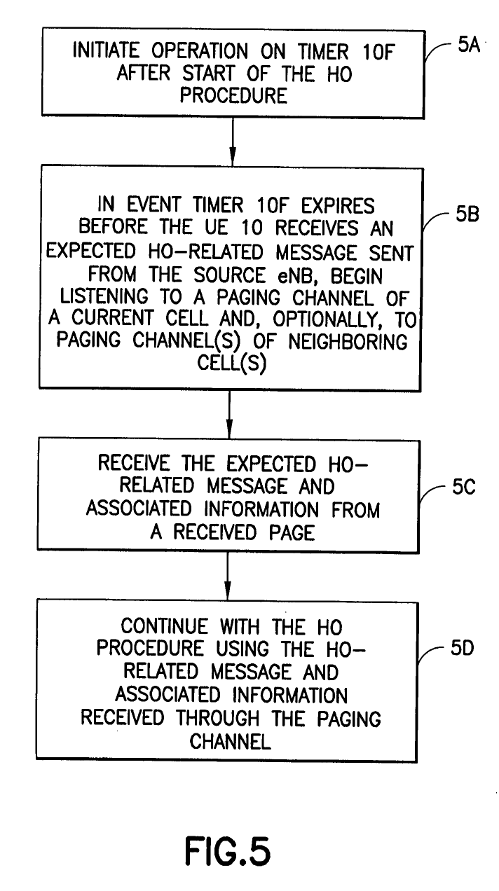

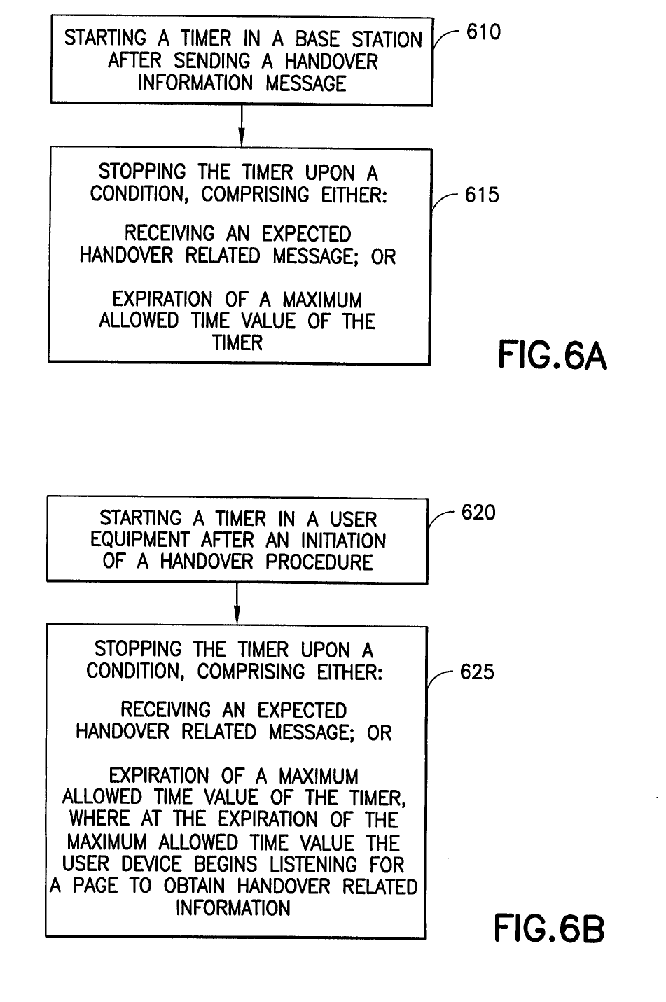

In FIG. 6 there is illustrated in flow chart form a method for each of a base station, and a user equipment according to an exemplary embodiment of the invention.

In FIG. 6A there is illustrated in a flow chart according to the invention a method of (610) starting a timer in a base station after sending a handover information message, and (615) stopping the timer upon a condition, comprising either receiving an expected handover related message; or expiration of a maximum allowed time value of the timer.

Further, in FIG. 6B there is illustrated in a flow chart according to the invention a method of (620) starting a timer in a user equipment after an initiation of a handover procedure, and (625) stopping the timer upon a condition, comprising either receiving an expected handover related message, or expiration of a maximum allowed time value of the timer, where at the expiration of the maximum allowed time value the user equipment begins listening for a page to obtain handover related information.

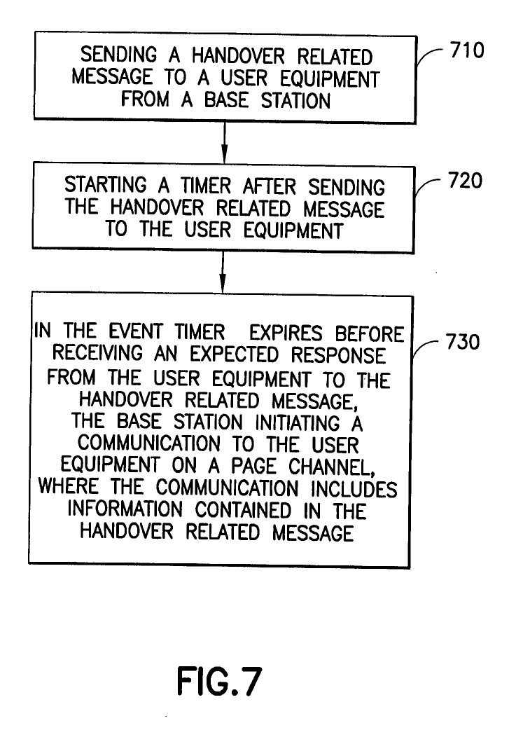

In FIG. 7 there is illustrated in a flow chart a method for a base station according to a non-limiting exemplary embodiment of the invention. According to the method there is (710) sending a handover related message to a user equipment from a base station, (720) starting a timer after sending the handover related message to the user equipment, and (730) in the event the timer expires before receiving an expected response from the user equipment to the handover related message, the base station initiating a communication to the user equipment on a page channel, where the communication includes information contained in the handover related message

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, logic flow diagrams, message flow diagrams, or by using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method, comprising:
starting a timer in a base station after sending a handover information message; and
stopping the timer upon a condition, comprising either:
receiving an expected handover related message; or
expiration of a maximum allowed time value of the timer.

2. The method of claim 1, comprising paging a user equipment at an expiration of the maximum allowed time value, where the paging comprises the handover information.

3. The method of claim 2, where the paging is of an ACTIVE state user equipment.

4. The method of claim 1, where the base station is a target base station, and where the timer is started after a context confirm message is sent to a source base station.

5. The method of claim 1, where the base station is a source base station, and where the timer is started after a handover command message is sent to a user equipment.

6. The method of claim 1, where the base station is a target base station, further comprising the target base station notifying a source base station of an expiration of the maximum allowed time value.

7. The method of claim 1, where the base station is a source base station, further comprising the source base station paging an ACTIVE state user equipment after receiving a notification from a target base station of an expiration of a maximum allowed time value.

8. The method of claim 1, further comprising
sending a notification message to a network element at an expiration of the maximum allowed time value if it is determined that a radio connection is lost; and
receiving at the base station in response to sending the notification message a page notification from the network element.

9. The method of claim 8, further comprising sending an IDLE state page to the user equipment in response to receiving the page notification.

10. A method, comprising:
starting a timer in a user equipment after an initiation of a handover procedure; and
stopping the timer upon a condition, comprising either:
receiving an expected handover related message; or
expiration of a maximum allowed time value of the timer, where at an expiration of the maximum allowed time value the user equipment begins listening for a page to obtain handover related information.

11. The method of claim 10, where the user equipment listens for the page in an ACTIVE state.

12. The method of claim 10, where at an expiration of the maximum allowed time value the user equipment enters an IDLE state and begins listening for an IDLE state page.

13. A computer readable medium encoded with a computer program executable by a processor to perform actions comprising:
starting a timer in a base station after sending a handover information message; and
stopping the timer upon a condition, comprising either:
receiving an expected handover related message; or
expiration of a maximum allowed time value of the timer.

14. The computer readable medium encoded with a computer program of claim 13, comprising paging a user equipment at an expiration of the maximum allowed time value, where the paging comprises the handover information.

15. The computer readable medium encoded with a computer program of claim 14, where the paging is of an ACTIVE state user equipment.

16. The computer readable medium encoded with a computer program of claim 13, where the base station is a target base station then starting the timer after a context confirm message is sent to a source base station.

17. The computer readable medium encoded with a computer program of claim 13, where the base station is a source base station then starting the timer after a handover command message is sent to a user equipment.

18. The computer readable medium encoded with a computer program of claim 13, where the base station is a target base station, the target base station notifies a source base station of an expiration of the maximum allowed time value.

19. The computer readable medium encoded with a computer program of claim 13, where the base station is a source base station, the source base station begins paging an ACTIVE state user equipment after receiving a notification from a target base station of an expiration of a maximum allowed time value.

20. The computer readable medium encoded with a computer program of claim 13, further comprising
sending a notification message to a network element at an expiration of the maximum allowed time value if it is determined that a radio connection is lost; and
receiving at the base station in response to sending the notification message a page notification from the network element.

21. The computer readable medium encoded with a computer program of claim 20, further comprising sending an IDLE state page to the user equipment in response to receiving the page notification.

22. A computer readable medium encoded with a computer program executable by a processor to perform actions comprising:
starting a timer in a user equipment after an initiation of a handover procedure; and
stopping the timer upon a condition, comprising either:
receiving an expected handover related message; or
expiration of a maximum allowed time value of the timer, where at an expiration of the maximum allowed time value the user equipment begins listening for a page to obtain handover related information.

23. The computer readable medium encoded with a computer program of claim 22, where the user equipment listens for the page in an ACTIVE state.

24. The computer readable medium encoded with a computer program of claim 22, where at an expiration of the maximum allowed time value the user equipment enters an IDLE state and begins listening for an IDLE state page.

25. An apparatus, comprising:
a handover control unit coupled to a transmitter configured to start a timer in a base station after sending a handover information message; and
the handover control unit coupled to a receiver configured to stop the timer upon a condition, comprising either:
receiving an expected handover related message; or
expiration of a maximum allowed time value of the timer.

26. The apparatus of claim 25, comprising the transmitter coupled to the handover control unit further configured to page a user equipment at an expiration of the maximum allowed time value, where the page comprises the handover information message.

27. The apparatus of claim 26, where the page is of an ACTIVE state user equipment.

28. The apparatus of claim 25, where the base station is a target base station then the handover control unit is configured to start the timer after a context confirm message is sent to a source base station.

29. The apparatus of claim 25, where the base station is a source base station then the handover control unit is configured to start the timer after a handover command message is sent to a user equipment.

30. The apparatus of claim 25, where the base station is a target base station, the target base station comprising the transmitter configured to notify a source base station of an expiration of the maximum allowed time value.

31. The apparatus of claim 25, where the base station is a source base station, the source base station comprising the transmitter configured to begin paging an ACTIVE state user equipment after receiving a notification from a target base station of an expiration of a maximum allowed time value.

32. The apparatus of claim 25, further comprising
the transmitter configured to send a notification message to a network element at an expiration of the maximum allowed time value if it is determined that a radio connection is lost; and
the receiver configured to receive at the base station in response to sending the notification message a page notification from the network element.

33. The apparatus of claim 32, further comprising the transmitter further configured to send an IDLE state page to the user equipment in response to receiving the page notification.

34. An apparatus comprising:
a handover control unit configured to start a timer in a user equipment after an initiation of a handover procedure; and
the handover control unit coupled to a wireless receiver further configured to stop the timer upon a condition, comprising either:
receiving an expected handover related message; or
expiration of a maximum allowed time value of the timer, where at an expiration of the maximum allowed time value the wireless receiver of the user equipment is further configured to begin listening for a page to obtain handover related information.

35. The apparatus of claim 34, where the user equipment listens for the page in an ACTIVE state.

36. The apparatus of claim 34, where at an expiration of the maximum allowed time value the user equipment enters an IDLE state and begins listening for an IDLE state page.

37. An apparatus, comprising:
means for starting a timer in a base station after sending a handover information message; and
means for stopping the timer upon a condition, comprising either:
receiving an expected handover related message; or
expiration of a maximum allowed time value of the timer.

38. The apparatus of claim 37, comprising a means for paging a user equipment at an expiration of the maximum allowed time value, where the paging comprises the handover information message.

39. The apparatus of claim 38, where the means for starting the timer after sending handover information to a user equipment comprises a transmitter coupled to a handover control unit; the means for stopping the timer comprises the handover control unit; and the means for paging comprises the transmitter coupled to the handover control unit.

40. An apparatus, comprising:
a means for starting a timer in a user equipment after an initiation of a handover procedure; and
a means stopping the timer upon a condition, comprising either:
receiving an expected handover related message; or
expiration of a maximum allowed time value of the timer, where at an expiration of the maximum allowed time value the user equipment begins listening for a page to obtain handover related information.

41. The apparatus of claim 40, comprising a means for the user equipment listening for the page in an ACTIVE state.

42. The apparatus of claim 40, where the means for starting the timer after the initiation of the handover comprises a wireless receiver coupled to a handover control unit; the means for stopping the timer comprises the handover control unit; and the means the user equipment listening for the page to obtain handover related information comprises the wireless receiver.

43. A method, comprising:
sending a handover related message to a user equipment from a base station;
starting a timer after sending the handover related message to the user equipment, and
in the event the timer expires before receiving an expected response from the user equipment to the handover related message, the base station initiating a communication to the user equipment on a page channel, where the communication includes information contained in the handover related message.

44. The method of claim 43, where the communication is an ACTIVE state page of the user equipment.
